(19) United States
(12) Patent Application Publication
(10) Pub. No.: US 2006/0152996 A1
(43) Pub. Date: Jul. 13, 2006

(54) Concrete mixer

(76) Inventors: Carlo Pachetti, Cascina (RI) (IT); Franco Bacchini, Pisa (IT)

Correspondence Address: MCGLEW & TUTTLE, PC, P.O. BOX 9227, SCARBOROUGH STATION, SCARBOROUGH, NY, 10510-9227, US

(21) Appl. No.: 11/123,137

(22) Filed: May 5, 2005

(30) Foreign Application Priority Data
Jan. 10, 2005 (IT) FI2005A0001

(51) Int. Cl. B28C 5/20

(52) U.S. Cl. 366/47; 366/233

(57) ABSTRACT

The present invention relates to a concrete mixer comprising a drum (1) sustained by a supporting structure (3) allowing the drum tilting, said drum (1) being connected with a motorgear unit (2) driving the rotation thereof around a respective longitudinal axis (z-z), wherein said drum (1) is provided with an annular track (14) exhibiting an external or circumferential edge (140) engaged by respective driving means comprising more rollers (20) which are apt to rotate about respective axis′, are connected with said motorgear (2) and interact with said edge (140) in points (CP) located on segments (S) joining the points of intersection of the axis′ of the rollers (20) and of the drum (1) with a plane traversing the track (14). (FIG. 14).

The present invention relates to a concrete mixer.

### BACKGROUND OF THE INVENTION

It is known that a concrete mixer is a building site machine comprising a metal drum, also known as “bucket”, provided with internal blades and coupled with a gearmotor, which makes the drum rotate at a preset angular velocity.

A known type of concrete mixer comprises a transmission system with pinion and crown gear located on the drum, which, therefore, generates, during the operational phase, a high level of noise and vibrations considered unacceptable by today's standards.

According to a more recent construction technique aimed at reducing noise levels, the shaft from the gearmotor is connected, in a central position, to the bottom of the drum which, however, remains suspended on the central axis. Therefore, the strong structural stress caused by workloads must be dealt with by reinforcing the structure of the bottom of the drum. For this reason, the drums in traditional concrete mixers are generally made of steel, with a central hub for suspension and motoring reinforced with steel discs. This, however, raises costs and manufacturing times, thereby highly affecting the total cost of the product.

### SUMMARY OF INVENTION

The main objective of this invention is to solve the above inconveniences.

This result has been achieved, according to the invention, by adopting the idea of making a concrete mixer having the characteristics disclosed in claim 1.

Further characteristics of the present invention are dealt with in the dependent claims.

Thanks to the present invention, it is possible to avoid the suspension and motoring of the drum on the central axis and, therefore, it is possible to create a lighter drum made of plastic material, without precluding the possible use of metal materials, with the bottom portion being exposed to less structural stress and without particular structural reinforcements. Moreover, a concrete mixer, according to the invention, allows a simplification of the motion transmission by employing the same drum as a component of the speed reduction system downstream of the motor driving the drum rotation. In addition, this concrete mixer is relatively easy to make, of low cost and reliable even after extensive use.

### BRIEF DESCRIPTION OF THE DRAWINGS

These and other advantages and characteristics of the invention will be best understood by anyone skilled in the art from a reading of the following description in conjunction with the attached drawings, given as a practical example of the invention, but not to be considered in a limitative sense, wherein:

FIG. 1 is a schematic front-lateral perspective of a concrete mixer, according to the invention;

FIG. 2 is a schematic front-lateral perspective of the detail of the drum and power unit in the concrete mixer in FIG. 1;

FIG. 3 is a schematic rear-lateral perspective of the detail in FIG. 2, where, for graphic clarity, the rod (60) is not represented;

FIG. 4 is a schematic lateral perspective of the detail in FIG. 2, where some parts are not represented so as to better illustrate others;

FIG. 5 is a schematic frontal perspective of the detail in FIG. 2, where some parts are not represented so as to better illustrate others;

FIG. 6 is a schematic perspective of the internal side of the frontal safety casing of the power unit of the present concrete mixer;

FIG. 7 is a perspective analogous to that of FIG. 5;

FIG. 8 is a section view taken along the line A-A in FIG. 7;

FIG. 9 is an enlarged view of the detail “H” in FIG. 8;

FIG. 10 is a partial rear perspective of the present concrete mixer;

FIG. 11 is a schematic section view of the bottom portion of the drum;

FIG. 12 is a schematic rear-lateral perspective of the connection between the pin (8), the band (7) and the rod (6);

FIG. 13 is an illustrative diagram of the contact points between the means of friction and the drum of the present concrete mixer.

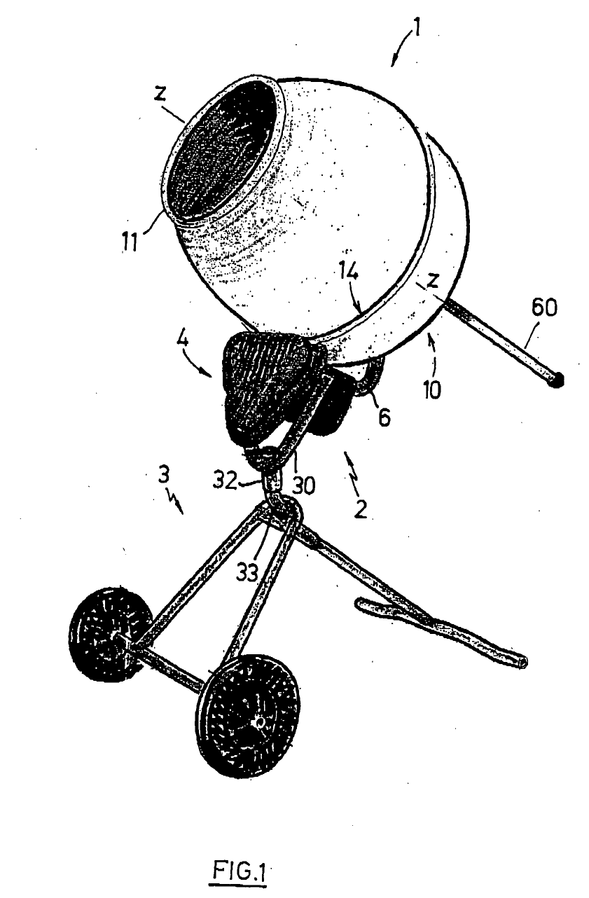

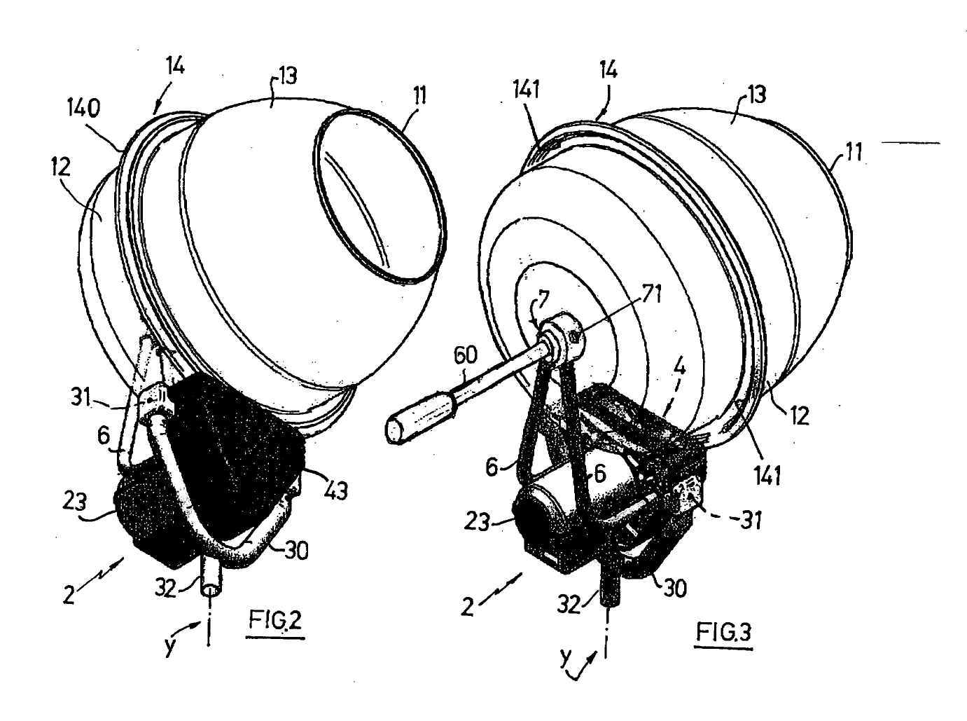

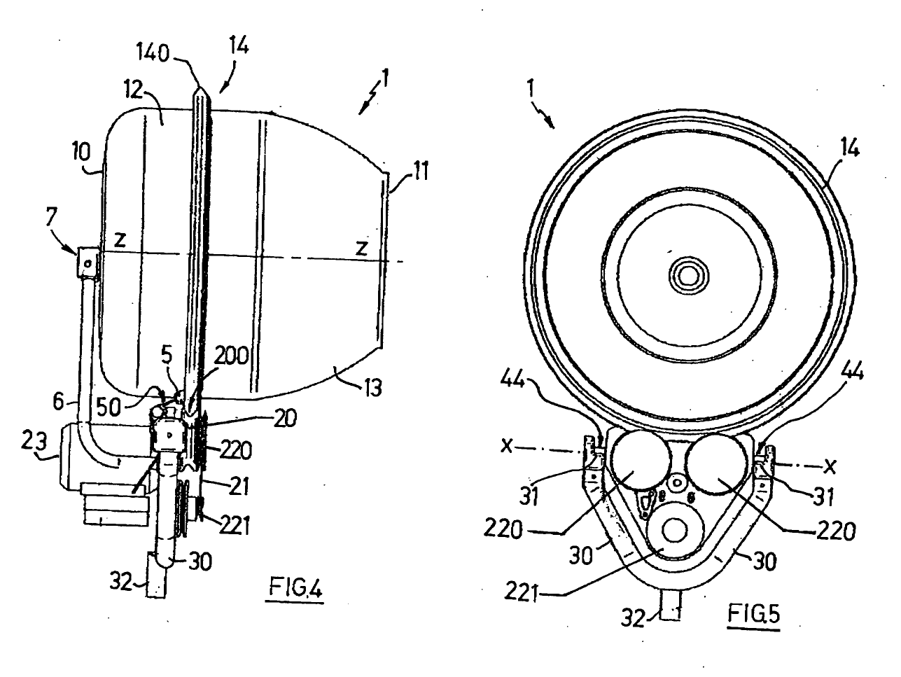

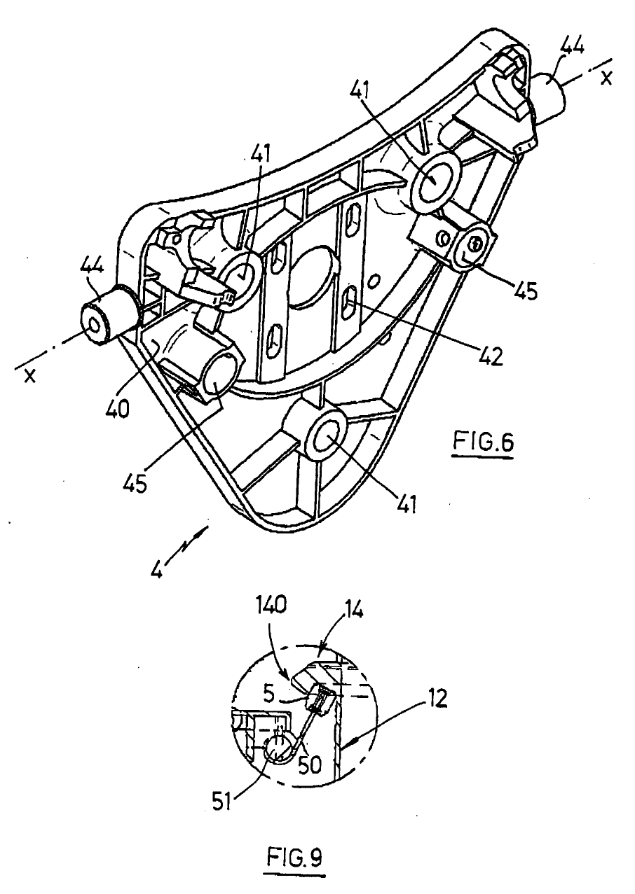

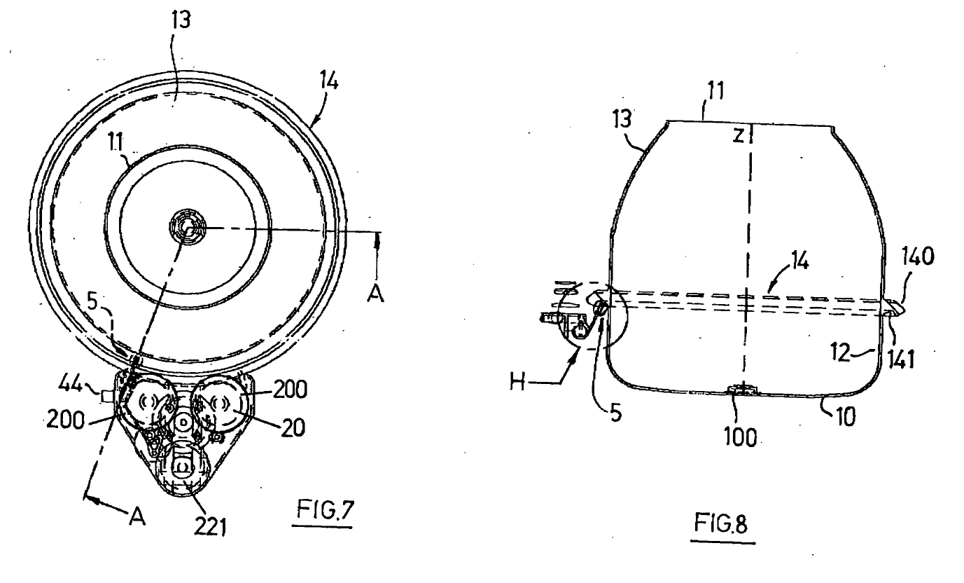

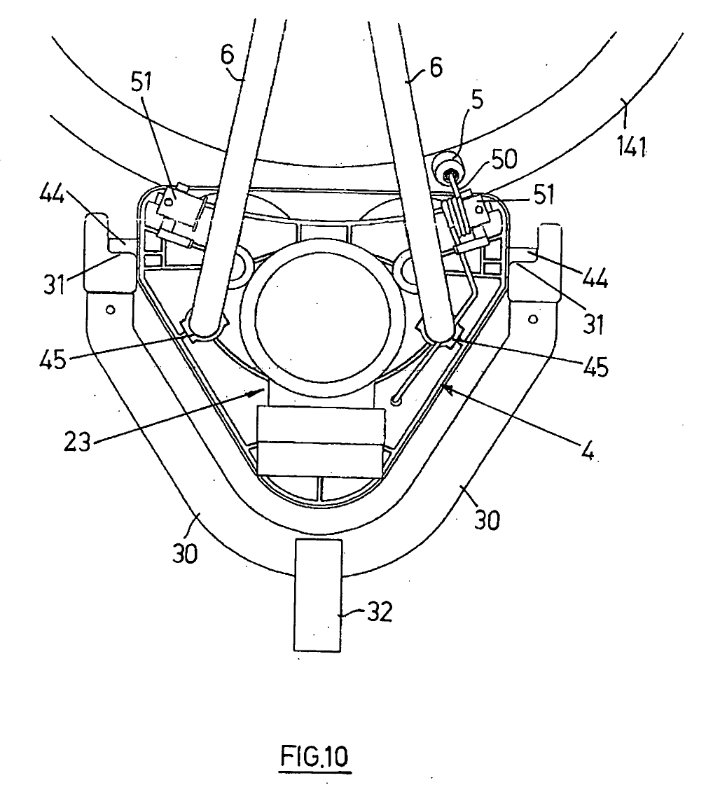

### DETAILED DESCRIPTION OF THE INVENTION

Reduced to its basic structure and with reference being made to the attached drawings, a concrete mixer, according to the invention, is comprised of a drum (1), or “bucket”, provided with internal blades (for graphic clarity, not represented in the drawings), capable of containing preset quantities of materials for the preparation of building mixtures. Said drum (1) is coupled with a gearmotor (2) which controls its rotation at a preset angular velocity, for example 24÷26 rpm, around the respective longitudinal axis (z-z). Moreover, the drum (1) is mounted on a tubular structure (3) and may rotate both around a vertical axis (y) and around a horizontal axis (x-x) of the same structure. The total height of the latter is such as to allow the clear tilting of the drum (1) during its emptying phase.

In more detail, such drum (1) is made as to exhibit a bottom surface (10) set in opposition to an open end (11) to put in the materials to be mixed and, respectively, to pour out the materials once they've been mixed, a portion of basically cylindrical lateral surface (12) between the bottom surface (10) and the open end (11) of a preset height, and a basically tapered portion of lateral surface (13) joining said portion of cylindrical surface (12) to said open end (11). The maximum diameter of the drum (1) is defined where said portion of cylindrical surface (12) meets the tapered portion (13).

Advantageously, on the external side of said portion of cylindrical surface (12) an annular track (14) is provided, exhibiting, in turn, a convex circumferential external edge (140), that is an edge having a convex perimeter with the convexity facing towards the outside of the drum (1), and a concave circumferential internal edge (141), that is a concave edge on the rear of the convex edge (140) and with the concavity facing towards the drum (1).

Advantageously, said track (14) functions both as a linkage between said parts (12) and (13) of the drum (1) as well as a stiffening ring along the support plane of the same drum close to the center of gravity at full load.

The convex edge (140) of said track (14), by friction, is in contact with two rollers (20). The edge of each roller exhibits a corresponding annular groove (200), with a “V” cross-section, which is in contact with said edge (140). Said rollers (20) are connected with the gearmotor (2) and the respective axis′ are parallel to the axis (z-z) of the drum (1).

The joint rotation of the rollers (20) determines the corresponding rotation of the drum (1) around the respective longitudinal central axis (z-z) due to the friction between the same rollers (20) and the edge (140) of the track (14) exhibited by the drum (1).

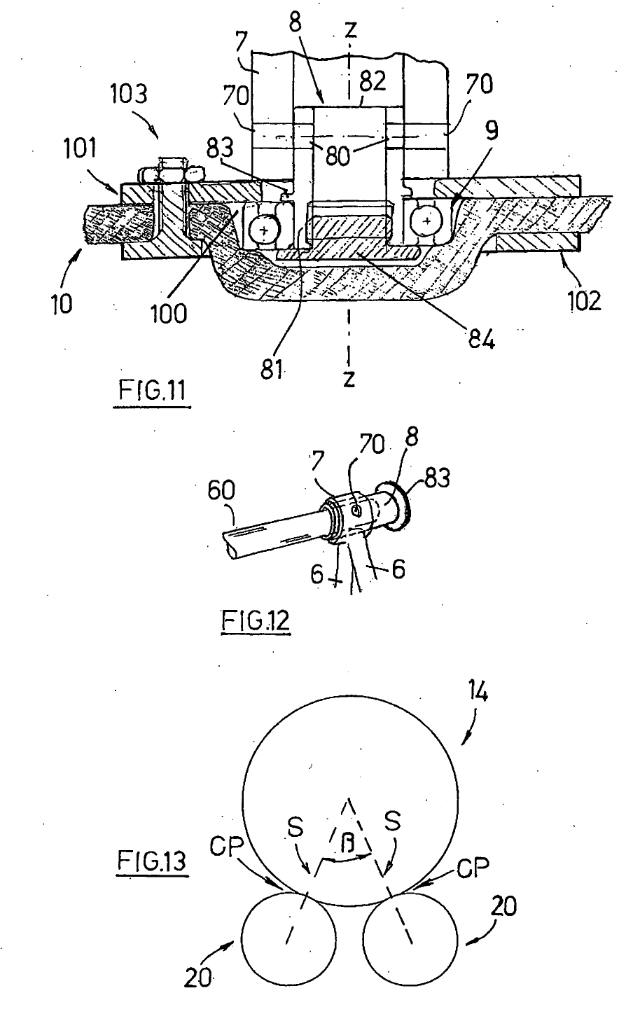

As shown in the diagram in FIG. 12, the contact points (CP) between the track (14) and the rollers (20) are located on segments (S) joining the points of intersection of the axis′ of the rollers (20) and of the drum (1) with a plane (in the drawing, the plane of the sheet) traversing the track (14).

Moreover, advantageously, said segments (S) delimit an angle (β) measuring less than 90°.

According to the example shown in the attached drawings, said gearmotor (2) comprises an electrical motor (23) connected with three pulleys (220, 221) connected to each other by a belt (21) and arranged with their respective axis′ parallel to the axis′ of said rollers (20), that is parallel to the axis (z-z) of drum (1). The axis of the motor (23) is also parallel to the axis (z-z). In more detail, two pulleys (220) of the gearmotor (2) are provided so that each one results on the external side of a corresponding roller (20) and fitted onto the relative axis. The third pulley (221) is equidistant to the first two pulleys (220), thus forming a triangle with the other two pulleys (220, 221). Moreover, the third pulley (221) is set into rotation by the motor (23) and then it, in turn, moves into rotation the other two pulleys (220) by means of a belt (21). And, since the pulleys (220) are fitted onto the axis′ of the rollers (20), even the latter rotate and consequently so does the drum (1). It must be noted that said track (14) lies in correspondence of a section of maximum diameter of the drum (1), automatically turning into an advantage the difference between such diameter and the diameter of the rollers (20)—which, as may be noted in the drawings, have a relatively small diameter—thereby further contributing to the reduction in number of rotations of the drum, allowing to reduce the mechanical complexity and costs of the gearmotor.

The axis′ of the rollers (20) and of the pulleys (220, 221), as well as the casing of the motor (23), are mounted onto a metal plate (4), which, on its respective internal side (40), is provided with corresponding seats (41) intended to receive corresponding free ends of said axis′, and also provided with multiple slotted holes (42) for screws intended engage the casing of the motor (23) from the outside.

Said plate (4) is also a safety and protection casing for the gearmotor (2).

The external side of said plate (4) is denoted by the reference number (43).

The plate (4) supporting the gearmotor (2) is provided with two coaxial transverse cylindrical appendices (44). The common axis of said appendices (44) coincides with the aforementioned horizontal axis (x-x).

The plate (4) is mounted upon a fork body (30) of the supporting structure (3), and is free to rotate around said axis (x-x).

In more detail, said fork body (30) is made of a metal tubular “U” shaped element, that is an element with two arms resulting at a preset distance between one another, with the end of each arm exhibiting a semi cylindrical cradle (31) which sustains a corresponding transverse appendix (44) of the plate (4).

In such way, the plate (4) is hinged to the two arms of the fork body (30) and is free to rotate around the axis (x-x).

In turn, the fork body (30) is provided with a vertical tubular appendix (32) intended to be fitted onto a vertical tubular body (33) protruding from the base of said structure (3).

In such way, the fork body (30) is free to rotate around the vertical axis (y) defined by the tubular body (33) of the structure (3) and, in conclusion, the plate (4), to which the gearmotor (2) is connected, is free to separately rotate around the horizontal axis (x-x) and around the vertical axis (y).

Two tapered rollers are in contact with the internal edge (141) of said annular track (14), each of said tapered rollers being facing a corresponding driving roller (20) on the opposite side of said annular track (14). In other words, while the driving rollers (20) engage the external edge (140) of the track (14), the rollers (5), on the opposite side, engage the internal edge (141) of the same.

The pressure thus applied by said rollers (5) contributes to ensuring a proper cohesion between the external edge (140) of the track (14) and the grooves (200) of the rollers (20).

Advantageously, each of said pressure rollers (5) is mounted on a corresponding elastic short arm (50) which helps keep the roller (5) in constant contact with the edge (141) of the track (14). Said arm (50) comprises an elastic element with a portion spiraling around a cylindrical core (51) set on the internal side of the plate (4).

For graphic clarity, only one pressure roller (5) is shown in the drawings.

The drum (1) is fixed to the plate (4) by means of two “L” shaped metal tubes (6), each one having one end set into a corresponding cylindrical seat (45) provided in the internal side of the plate (4) and the other end fixed to the bottom (10) of the drum (1). According to the example shown in the attached drawings, the drum (1) is fastened to said tubes (6) by means of a tubular metal band (7) welded to the tubes (6). The tubular band (7) is positioned so that its axis is oriented towards the axis (z-z) of the drum (1) and it is provided with two radial opposing holes (70) intended for the insertion of a screw (71) to fasten a tubular pin (8), the latter being provided with corresponding holes (80) and being positioned coaxially with, and partially inside, the band (7). Said tubular pin exhibits a threaded end (81) opposite the extremity (82) of the band (7) and is provided with a reference block (83) at a preset distance from the threaded end (81) into which a plug (84) is screwed. The block (83) of the pin (8) and the head of the plug (84) are set inside a slot (100) in the external side of the bottom (10) of the drum and, on opposite sides, engage the internal ring of a bearing (9). The latter is also set in said slot (100) and is fitted onto the segment of the pin (8) resulting between the block (83) and the pin's (8) terminal expansion which consists, according to the given example, of the threaded plug (84). The external ring of the bearing (9) is in contact with, on one side, the internal surface of said slot (100) and, on the other side, a flange (101) set on the external side of the bottom (10) of the drum. Said flange (101) is fastened to the bottom (10) of the drum by means of a second flange (102) set on the internal side of the bottom (10) of the drum and by means of screws (103) passing through the two flanges (101, 102) and the bottom (10) of the drum. In such way, the drum (1) is connected to the tubes (6), and thereby to the plate (4), and is free to rotate around the respective axis (z-z) and, moreover, is tightly fastened so as to prevent its fall during its tilting and pouring out of the mixtures therein prepared.

Moreover and advantageously, the concrete mixer is equipped with a control rod (60), functioning as a handle for the operator to use for the tilting of the drum (1), that is to use for the rotation of the drum (1) around the axis (x-x) or around the axis (y) of the supporting structure. In the example shown in the attached drawings, said rod (60) is partially inserted from the rear into said pin (8) and fastened to it by the same screw (71) that secures the pin (8) to the tubular band (7): to this end, the rod (60) is adequately equipped with radial holes corresponding to the holes (70, 80) analogously provided in the band (7) and in the pin (8).

Practically, the construction details may vary in any equivalent way as far as the shape, dimension, disposition of elements, nature of the used materials, without nevertheless departing from the scope of the adopted solution idea and, thereby, remaining within the limits of the protection granted to the present patent.

What is claimed is:

1. A concrete mixer comprising a drum (1) sustained by a supporting structure (3) allowing the drum tilting, said drum (1) being connected with a motorgear unit (2) driving the rotation thereof around a respective longitudinal axis (z-z), wherein said drum (1) is provided with an annular track (14) exhibiting an external or circumferential edge (140) engaged by respective driving means comprising more rollers (20) which are apt to rotate about respective axis′, are connected with said motorgear (2) and interact with said edge (140) in points (CP) located on segments (S) joining the points of intersection of the axis′ of the rollers (20) and of the drum (1) with a plane traversing the track (14).

2. The concrete mixer of claim 1 wherein the axis′ of said rollers (20) are parallel to longitudinal axis (z-z) of said drum (1).

3. The concrete mixer of claim 1 wherein each of said said rollers (20) is provided with an annular concave groove engaging, by friction, the external edge (140) of said annular track (14), said external edge (140) being convex with the convexity facing towards the outside of the drum (1).

4. The concrete mixer of claim 1 wherein said track (14) is in correspondence of a maximum diameter portion (12) of said drum (1).

5. The concrete mixer of claim 1 wherein said track (14) is provided with a concave circumferential internal edge (141), that is a concave edge on the rear of the external edge (140) and with the concavity facing towards the drum (1), said internal edge (141) being engaged by more pressure rollers (5).

6. The concrete mixer according of claim 1 wherein said rollers (20) are sustained by a plate (4) which also supports said motorgear unit (2).

7. The concrete mixer of claim 6 wherein said plate (4) is hinged, free to rotate about an horizontal axis (x-x), onto a corresponding element (30) of said structure (3).

8. The concrete mixer of claim 7 wherein said element (30) is provided with two semi cylindrical cradles (31) each of which sustains a corresponding cylindrical appendix (44) of said plate (4), said cylindrical appendixes being coaxial and disposed along said axis (x-x).

9. The concrete mixer of claim 7 wherein said element (30) is mounted onto said structure (3) free to rotate about a vertical axis (y).

10. The concrete mixer of claim 5 wherein said pressure rollers (5) are mounted onto corresponding elastic arms (50).

11. The concrete mixer of claim 1 wherein the bottom of said drum (1) is provided with a seat (100) for means which firmly support the drum (1) during work and tilting phases, allowing its free rotation about the respective axis (z-z).

12. The concrete mixer of claim 11 wherein said supporting means provided on the bottom (10) of the drum are made up of a bearing whose external ring is made solid to the drum by means of a mechanical connection.
